(19) United States
(12) Patent Application Publication
(10) Pub. No.: US 2008/0037511 A1
(43) Pub. Date: Feb. 14, 2008

(54) Supporting coordinated communication services

(76) Inventors: Alessio Casati, Swindon (GB); Fang-Chen Cheng, Randolph, NJ (US); Sudeep Palat, Swindon (GB); Said Tatesh, Swindon (GB)

Correspondence Address: CARLSON, GASKEY & OLDS, P.C., 400 W MAPLE RD, SUITE 350, BIRMINGHAM, MI, 48009, US

(21) Appl. No.: 11/503,857

(22) Filed: Aug. 14, 2006

(51) Int. Cl. H04J 3/06

(52) U.S. Cl. 370/350; 370/516

(57) ABSTRACT

A communication system includes a decentralized, flat architecture where a plurality of base nodes each include controller capabilities so that a centralized base node such as a radio network controller is not required. At least one of the base nodes acts as an anchor node. The anchor node associates a time stamp with at least one packet and provides that to the plurality of base nodes. In one example, a multicast approach is used by a router device for distributing the packet and the associated time stamp to the plurality of base nodes. Each base node controls a timing of a transmission of the at least one packet over a wireless interface responsive to the associated time stamp.

### 1. FIELD OF THE INVENTION

This invention generally relates to communication. More particularly, this invention relates to coordinated communications using a plurality of transmitters.

### 2. DESCRIPTION OF THE RELATED ART

Wireless communication systems are well known and in widespread use. The traditional model has been to deploy base stations to provide wireless coverage over corresponding geographic regions that are referred to as cells. Each base station is controlled by a controller such as a radio network controller. In traditional system architectures, the radio network controller is responsible for controlling a plurality of base stations. Having a single control point makes it relatively simple to coordinate transmissions among different base stations. For example, where a simultaneous or synchronized transmission from more than one base station is required, a radio network controller can allocate appropriate resources to each base station and cause appropriate control to achieve the desired timing of the transmissions.

More recently, other arrangements have been proposed. Flat network architectures integrate the radio network controller functions into each base station (eNB). Decentralizing the controller functions in this way is intended to improve system performance in terms of call set up delay and is intended to avoid a complex centralized node that tends to be a bottleneck and a potential single point of failure in the traditional architecture. Without a centralized radio network controller, functions like data synchronization and scheduling for multicast/broadcast services (MBMS) becomes a challenge. With a centralized radio network controller, resource blocks and data are controlled and allocated to ensure that data from different cells are transmitted synchronously. For flat network architectures, there is no such solution and it is necessary to provide an ability to facilitate MBMS communications in such systems. This invention addresses that need.

### SUMMARY OF THE INVENTION

An exemplary method of communicating includes controlling a timing of a transmission of at least one packet from a base node responsive to a time stamp associated with the at least one packet by one of the base node or another base node.

In one example, controlling the timing achieves a simultaneous transmission of the at least one packet by a plurality of base nodes.

In one example, one of the base nodes acts as an anchor node. The at least one packet is provided to the anchor node. A time stamp is associated with the at least one packet by the anchor node. The at least one packet and the associated time stamp is then provided to the plurality of base nodes that are to transmit the at least one packet responsive to the associated time stamp.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example communication system that is useful with an embodiment of this invention.

FIG. 2 is a schematic illustration of another use of the arrangement schematically shown in FIG. 1.

FIG. 3 is a flowchart diagram summarizing one example approach useful with an embodiment of this invention.

### DETAILED DESCRIPTION OF THE PREFERRED EMBODIMENT

Disclosed example embodiments allow for achieving coordinated transmissions from a plurality of base nodes in a so-called flat architecture configuration that does not include a centralized base station controller, but instead has controller capabilities at each base node. In disclosed examples, at least one base node acts as an anchor node to associate a time stamp with at least one packet. The plurality of base nodes use the associated time stamp for controlling timing of transmission of the at least one packet from each base node, respectively. A disclosed example includes multicasting the at least one packet with the associated time stamp to the plurality of base nodes for enhanced efficiency.

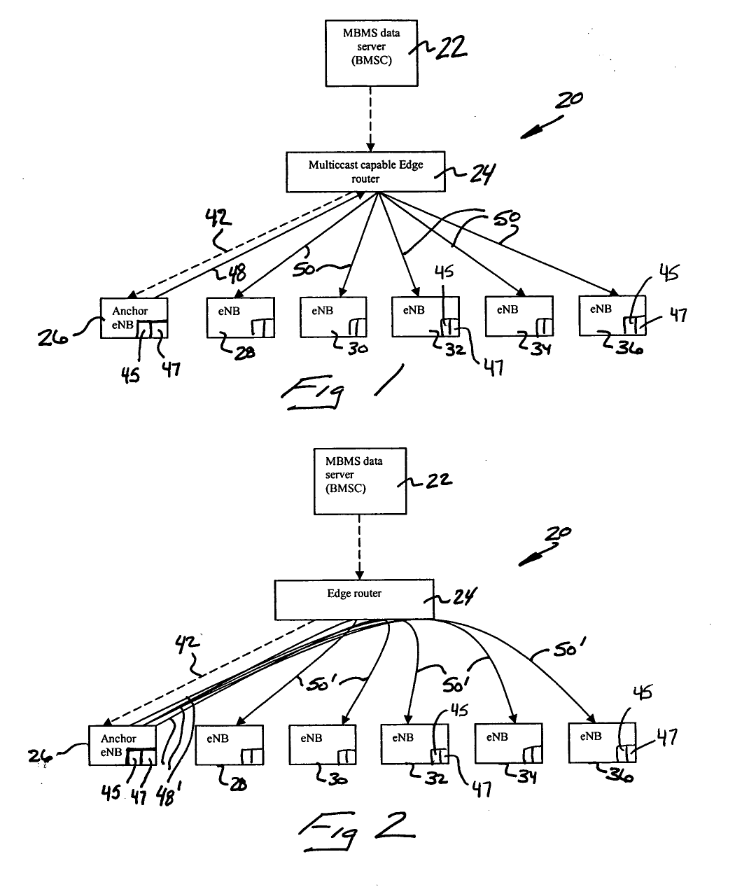

FIG. 1 schematically illustrates selected portions of an example communication system 20. A multicast/broadcast service (MBMS) data server 22 processes at least one packet (e.g., a data packet) that is to be part of MBMS to at least one subscriber device such as a mobile station. The illustrated example includes a router device 24 that communicates with the MBMS data server 22 in a known manner. The example router device 24 comprises an edge router that communicates with a plurality of base nodes 26, 28, 30, 32, 34 and 36. In one example, the communications between the base nodes 26-36 and the router device 24 occur over an Internet Protocol (IP) network.

FIG. 3 includes a flowchart diagram 40 that summarizes one example approach for coordinating transmissions from the base nodes 26-36 to achieve MBMS, for example. As shown at 42, the edge router 24, having received the at least one packet from the data server 22, sends that packet to an anchor node. In the example of FIG. 1, the base node 26 operates as an anchor node and the packet from the data server 22 goes through the router device 24. In another example, the router device is not involved in the communication between the data server 22 and the anchor node 26. At 44, the anchor node 26 receives the at least one packet. The illustrated example includes a transceiver portion 45 for receiving the at least one packet and for transmitting packets from the anchor node 26.

As shown at 46 in FIG. 3, the anchor node 26 associates a time stamp with the at least one packet. In the example of FIG. 1, the anchor node 26 includes a controller portion 47 that controls the time stamp and associates it with the at least one packet. The time stamp is used by the plurality of base nodes for coordinating the timing of the transmission of the at least one packet from each of the base nodes, respectively. In this regard, the controller portion 47 of the anchor node 26 defines the strategy and execution of data synchronization among the base nodes. The anchor node 26, and in the illustrated example the controller portion 47, determines at which time the at least one packet must be sent by each of the base nodes. In the case of MBMS, the timing of the transmission will be synchronized so that a simultaneous transmission occurs. While the illustrated example is particularly useful for MBMS, other coordination strategies among transmissions from various base nodes may be accomplished using the disclosed technique of the illustrated example.

In one example, the controller portion 47 associates the time stamp with the at least one packet by including an indication of a real time or a radio sub frame number as the time stamp. In one example, the time stamp information is included in the header of the packet. In another example, the time stamp information refers to a frame number of a higher layer protocol, such as TCP or RTP.

At 48, the at least one packet and the associated time stamp are transmitted by the transceiver portion 45 to the router device 24. At 50, the router device 24 forwards the at least one packet with the associated time stamp to each of the plurality of base nodes 28-36. At 60, each base node, including the anchor node 26 in this example, controls the timing of transmission of the at least one packet over a wireless interface, the example, responsive to the associated time stamp. The controller portion 47 of each base node determines the appropriate transmit time based upon the time stamp information.

The example of FIG. 1 provides an advantageously efficient arrangement by using an IP transport network for communicating between the router device 24 and the base nodes 26-36. In the example of FIG. 1, forwarding the at least one packet with the associated time stamp to the plurality of base nodes includes using a multicast technique as schematically shown. In one example, when a new service or flow is started, only the anchor node 26 joins that service initially. The router device 24 includes information regarding at least one multicast group, which is defined in one example by a multicast IP address. Any base node that is part of that multicast group in one example joins the group using a known IGMP join message to be included in the multicast distribution of the at least one packet with the associated time stamp. This example arrangement provides for an efficient distribution of the at least one packet and the associated time stamp because only one copy need be sent by the anchor node 26 and then redistributed in a multicast form by the router device 24. In the example of FIG. 1, the router device 24 is a multicast capable edge router.

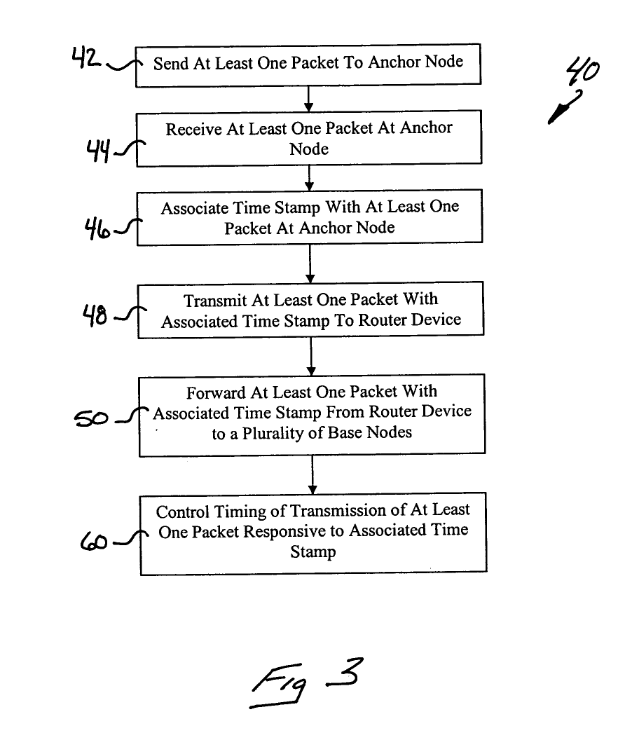

In the example of FIG. 2, a different distribution technique is used. In this example, the anchor node 26 transmits the at least one packet with the associated time stamp at 48′ multiple times to the other base nodes. These transmissions in the illustrated example are sent via the router device 24. The distribution to each of the other base nodes occurs at 50′ by having each transmission forwarded by the router device 24, individually. This example arrangement may be used where an IP transport network or IP multicast capabilities are not available. This example still provides for at least one base node to operate as an anchor node for coordinating the timing of transmissions of the at least one packet from the plurality of base nodes.

By using at least one of the base nodes as an anchor node in the illustrated examples, the need for a centralized controller or node for synchronizing or coordinating transmissions in a distributed, flat network can be accomplished without a centralized node or controller.

In one example, at least one other of the base nodes operates as a backup anchor node. The base node 30, for example, will receive the initial transmission of the at least one packet occurring at 42 at the same time as the anchor node 26 receiving the at least one packet from the router device 24. The base node 30 includes a controller portion 47 that determines whether the base node 30 subsequently receives the same packet with the associated time stamp. In one example, an expected period of time is allowed to elapse within which the packet with the associated time stamp is expected. If the packet with the associated time stamp is not subsequently received by the base node 30, a determination is made that the anchor node 26 has failed and the base node 30 operates as if it were the anchor node and the controller portion 47 of the base node 30 associates a time stamp with the at least one packet and transmits that to the router device 24 for distribution to the plurality of base nodes as described above.

In such an example, at least one base node operates as a backup for another one of the base nodes that normally serves as the anchor node for at least one session. Such an example provides additional flexibility especially compared to traditional systems where one centralized node was required for coordinating transmissions among various base stations.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
controlling a timing of a transmission of at least one packet from a base node responsive to a time stamp associated with the at least one packet by one of the base node or another base node.

2. The method of claim 1, comprising
controlling the timing to achieve a simultaneous transmission of the at least one packet by a plurality of base nodes.

3. The method of claim 1, comprising
receiving the at least one packet at the base node;
associating the time stamp with the at least one packet, where the time stamp provides an indication of a transmission time; and
forwarding the at least one packet with the associated time stamp to at least one other base node.

4. The method of claim 3, wherein the forwarding comprises
transmitting the at least one packet with the associated time stamp to the at least one other base node.

5. The method of claim 1, comprising
receiving the at least one packet with the associated time stamp at the base node.

6. The method of claim 1, comprising
transmitting the at least one packet to the base node;
receiving the at least one packet with the associated time stamp from the base node; and
transmitting the at least one packet with the associated time stamp to at least one other base node that will control the timing responsive to the time stamp.

7. The method of claim 6, comprising
receiving a single transmission of the at least one packet with the associated time stamp at a router device; and
multicasting the at least one packet with the associated time stamp to a plurality of base nodes.

8. The method of claim 7, comprising
establishing a multicast group of base nodes including the plurality of base nodes that will control timing of the transmission responsive to the time stamp.

9. The method of claim 1, comprising
operating a first base node as an anchor node for associating the time stamp with the at least one packet;
operating a second base node as the anchor node for associating the time stamp with the at least one packet if the first base node failed to associate the time stamp with the at least one packet.

10. The method of claim 9, comprising
using the second base node for determining if the first base node has failed to associate the time stamp with the at least one packet by
receiving the at least one packet at the second base node;
determining whether the at least one packet is subsequently received at the second base node with the associated time stamp.

11. A communication system, comprising
a source of data;
a plurality of base nodes;
an anchor base node that receives at least one packet from the source of data and associates a time stamp with the at least one packet, the anchor base node transmitting the at least one packet with the associated time stamp to the plurality of base nodes that receive the at least one packet with the associated time stamp and control a timing of a respective transmission of the at least one packet responsive to the time stamp.

12. The system of claim 11, comprising
a router device that receives a single transmission of the at least one packet with the associated time stamp from the anchor base node and multicasts the at least one packet with the associated time stamp to the plurality of base nodes.

13. The system of claim 11, comprising
a router device that receives multiple transmissions of the at least one packet with the associated time stamp from the anchor node and forwards each received transmission to a corresponding one of the plurality of base nodes.

14. The system of claim 11, wherein at least one of the plurality of base nodes operates as a backup anchor node for associating the time stamp with the at least one packet if the anchor node fails to associate the time stamp with the at least one packet.

15. The system of claim 11, wherein the anchor node and the plurality of nodes simultaneously transmit the at least one packet.

16. A base node device, comprising
a transceiver portion for at least transmitting at least one packet to at least one other device; and
a controller that controls the transmitter for controlling a timing of the transmitting of the at least one packet responsive to a time stamp associated with the at least one packet by one of the base node device or another base node.

17. The device of claim 16, wherein
the transceiver portion receives the at least one packet;
the controller associates the time stamp with the at least one packet; and
the transceiver portion transmits the at least one packet with the associated time stamp to at least one other device.

18. The device of claim 16, wherein
the transceiver portion receives the at least one packet;
the controller determines whether the transceiver portion subsequently receives the at least one packet with the associated time stamp; and
the controller associates the time stamp with the at least one packet if the transceiver portion does not subsequently receive the at least one packet with the associated time stamp.

19. The device of claim 16, wherein
the transceiver portion receives the at least one packet with the associated time stamp.
